(19) United States
(12) Patent Application Publication
(10) Pub. No.: US 2005/0197898 A1
(43) Pub. Date: Sep. 8, 2005

(54) Slow seller management system and method

(75) Inventors: Thomas Veit, Kirchheimbolanden (DE); Ines Wannemacher, Saarbrucken (DE); Susanne Ziehl, Blieskastel (DE); Thomas Roth, Norderstedt (DE); Ruediger Zuerl, Eschelbronn (DE)

Correspondence Address: FOLEY & LARDNER, 777 EAST WISCONSIN AVENUE, SUITE 3800, MILWAUKEE, WI, 53202-5308, US

(73) Assignee: SAP Aktiengesellschaft

(21) Appl. No.: 10/903,891

(22) Filed: Jul. 30, 2004

Related U.S. Application Data
(60) Provisional application No. 60/551,221, filed on Mar. 8, 2004.
(60) Provisional application No. 60/563,284, filed on Apr. 16, 2004.

(51) Int. Cl. G06F 17/60

(52) U.S. Cl. 705/14

(57) ABSTRACT

A method, program product and system for managing the sale of a product or service. The method includes determining if the product or service is a slow seller, determining a markdown to be applied to a price of the product or service, reconciling a markdown budget with the determined markdown to be applied to the price to determine whether the markdown will be applied, and adjusting the price of the product or service by the markdown. The markdown can be determined using a markdown profile. The determination of the slow seller can be made by applying a predetermined rule set to the product or service.

### RELATED APPLICATIONS

This application claims the benefit of priority to U.S. Provisional Patent Application Ser. No. 60/551,221, filed on Mar. 8, 2004 and U.S. Provisional Patent Application Ser. No. 60/563,284, filed on Apr. 16, 2004, the entire contents of which are incorporated herein by reference.

### BACKGROUND OF THE INVENTION

A. Field of the Invention

The present invention is directed to the field of marketing products and services and specifically to the management of products and services determined to be selling too slowly to reach sales quotas.

B. Background

Effective pricing of products that are made available for sale is often a complicated task. In order to maximize profits, not only must revenue be optimized, but also the costs of inventory must be taken into account. One strategy used is to periodically reduce the price of the products or services, effecting a markdown, in order to encourage sales of the products or services. The amount of the markdown is often set by a sales agent who has had experience in the market for the products or services and can, using his or her experience and intuition determine the timing and amount of markdowns.

In particular, the sale of seasonal products poses a high financial risk for merchants. This risk is even more acute in the retail business. Each seasonal article can be assigned a specific sales period. When high-fashion and fashion articles are involved, the merchant wants to have as little remaining stock as possible at the end of the sales period, as it will be difficult to sell this merchandise even with markdowns. In this case, larger remaining stocks translate to higher losses. In addition to fashion articles, such as pink raincoats, this also applies to other products, such as computer hardware.

For less “fashionable” products, the risk is lower because merchants can store any remaining stock and then try to sell it at the normal price again in the same season of the next year. Because storing inventories is expensive, however, merchants will generally prefer to sell their merchandise by the end of the regular sales period.

Merchants use markdowns to ensure that the merchandise is sold out as completely as possible by the end of a season. Markdowns are price reductions or buyer's incentives aimed at promoting the sale of certain articles. Of course, markdowns reduce the gross margin, which means the revenue merchants earn for selling the merchandise is less than originally planned. Merchants usually plan a certain budget for markdowns that must not be exceeded. Accordingly, markdowns are applied restrictively in retail, which once again increases the risk of remaining stocks at the end of the season.

Therefore, a goal in managing seasonal merchandise can be to limit markdowns to a minimum and apply them at the best suitable time, while ensuring that all or nearly all the merchandise is sold by the end of the season.

### SUMMARY OF THE INVENTION

An embodiment of the present invention discloses a method, program product and system for managing the sale of a product. The method includes determining if the product is a slow seller, determining a markdown to be applied to a price of the product, reconciling a markdown budget with the determined markdown to be applied to the price to determine whether the markdown will be applied, and adjusting the price of the product by the markdown. The markdown can be determined using a markdown profile. The determination of the slow seller can be made by applying a predetermined rule set to the product.

Other features and advantages of the present invention will become apparent to those skilled in the art from the following detailed description. It should be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The foregoing advantages and features of the invention will become apparent upon reference to the following detailed description and the accompanying drawings, of which:

FIG. 1 illustrates a markdown profile in accordance with an exemplary embodiment of the invention;

FIG. 2 is a flowchart illustrating basic price control and modification under an embodiment of the present invention; and

FIG. 3 is a flowchart illustrating slow seller management techniques under an embodiment of the present invention.

### DETAILED DESCRIPTION OF EXEMPLARY EMBODIMENTS

A slow seller, in accordance with the present invention, is a product or service that is selling more slowly than anticipated or that is selling at a pace where it becomes unlikely that a target sales quota will be reached. It is important to be able to identify such products and services quickly during a sales cycle and to take remedial measures to improve sales or minimize the negative effects of the lagging sales.

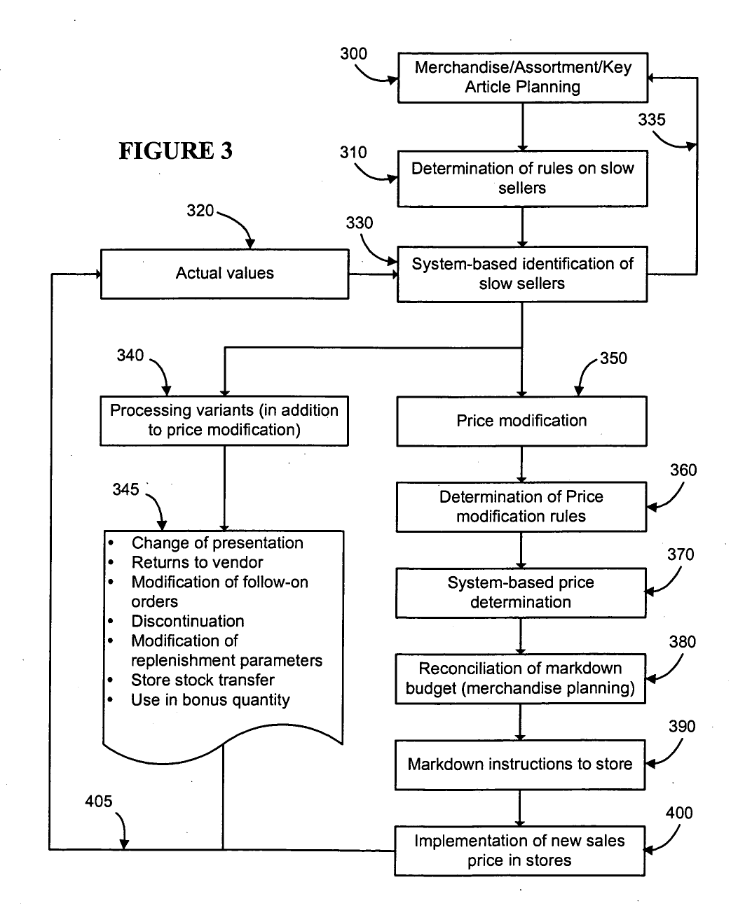

FIG. 3 is a flow chart illustrating slow seller management techniques under an embodiment of the present invention. Slow seller management begins with merchandise and assortment planning as shown in a step 300. Merchandise and assortment planning refer to the general distribution of products and services selected for marketing by a retailer or other entity. An assortment plan provides information such as the identification of the products and services, the quantities, the colors, the sizes, other characteristic traits, the location of products, the target customers, the time frame for marketing such products and services, the length of time they should be offered, anticipated sales curves, target inventory stocks, and costs incurred from inventory.

Initially, slow seller management is based on default values from the merchandise and assortment planning. The default values include inventory turnover, sales curves, target stocks, and costing incurred for a specific product or service or category of products or services. The next step in the slow seller management system and method is a determination of what set of rules to apply to determine slow sellers, shown as a step 310 in FIG. 3. To determine a slow seller, that is a product or service that is selling more slowly than anticipated or too slowly to reach target quotas, it is envisioned that such information as past sales, inventory or stock values, and the accrued cost of inventory will be analyzed. Using such factors, slow sellers can be identified.

Of course, many different sets of rules using any combination of the above or other factors can be established. Indeed, different categories of products and services may have different sets of rules used to determine slow sellers. For a specific category of products or services, multiple sets of rules may be applied that vary depending on how aggressively the user wants to manage the inventory.

In addition, the determinations in step 310 include determining the frequency with which the slow seller determination is carried out, the timing of such determination, and as briefly addressed above the determination of what indicators and what selection criteria to use.

A step 320 in FIG. 3 shows the introduction of actual values, that is, the actual sales figures from the various stores (not shown), being introduced into the slow seller management system. These actual values are used in a step 330 for the system to identify slow sellers based on the rules set forth in step 310.

Once one or more slow sellers have been identified in step 330, the slow seller management system and method proceeds to remedial measures to help increase sales of that products or service or to minimize the negative effects caused by the lagging sales. These remedial measures may include, as shown in a step 340, a change in the presentation of such products or services, effecting returns of such products to vendors, modification of follow-on orders, discontinuation of the products or services, modification of replenishment parameters, transfer from one store to the other of existing inventory, and the use in bonus quantity (e.g., buy one get one free promotions).

In addition to the exemplary remedial measures discussed with respect to step 340, the main remedial measure in slow seller management may be price modification as shown in step 350. Price modification can be performed in place of or in addition to the remedial measures discussed with respect to step 340. In accordance with an exemplary embodiment of the present invention, when a slow seller has been identified, active steps are taken to modify the price of the corresponding products and services in order to secure planned sales and reach targeted ending stock. Price modification is based on a set of previously defined rules that is used to determine the articles to be marked down, by how much, and the new sales price, taking into account existing prices. An example of a set of such markdown rules is the use of the markdown profile as described herein.

A step 360 illustrates the determination of what price modification rules to apply. One example of this is the determination of what markdown profile to use based on what markdown profile or profiles have been assigned to the product or service in question that has been identified as a slow seller.

In a step 370, the system makes a price modification determination based on the determined price modification rules, for example the markdown profile. The resulting impact on sales is then simulated using the modified pricing. These results are then reconciled with the markdown budget as described in greater detail in a later section herein and as shown in a step 380.

Upon reconciliation with the markdown budget, if it is determined that the price modification can be made in a step 390, the markdown instruction is sent to the store or stores where the products or services are sold. Then, in a step 400, the modified pricing is implemented in the stores for subsequent sales of the products or services. The expectation is that the modified pricing will spur sales of the slow seller. Subsequent sales will affect the actual values being entered into the slow seller management system and method and will cause a revision, if necessary, to the pricing, based on the rules and their application as set forth above.

A slow seller management process such as described provides several feedback loops that may be used manage slow sellers in both the current season and subsequent seasons. For example, the modified prices implemented in the stores in step 400 may result in relatively rapid changes in actual values (e.g., increased sale quantities) which are provided by step 320 to step 330 for additional slow seller determinations in the current season. This inter-seasonal feedback is indicated by a line 405 between steps 400 and 320. Moreover, the results of slow management may also be incorporated into the planning for subsequent seasons. For example, when items sell slowly in one season it may be desirable to ordered smaller quantities of those articles for the next season. This intra-seasonal feedback is shown by a line 335 between steps 330 and 300. Another feedback loop that may exist in an exemplary slow seller process is between markdown budget reconciliation step 380 and slow seller rules determination step 310. For example, the rules for slow sellers may be determined in step 310 based in part on the amount or size of the available budget for markdown, which available budget may be impacted upon implementation of steps 350-380.

As mentioned above, one of the primary goals in managing seasonal merchandise and services is to limit markdowns to a minimum and to apply them at the best suitable time, while ensuring that nearly all the merchandise is sold by the end of the season. An advantageous tool or system is described herein that supports a pricing agent's work during the ongoing season, such as a retail season. The agent forms a correspondence between an article and a markdown profile. This markdown profile contains time-specific target data for selling an article during its retail life cycle. The sales data of an article that sold well in the previous year, for example, could be used as the target sales quota in a markdown profile. The markdown profile is tied to a pricing strategy, which dictates specific price reductions when the actual sales data deviates from the target data. As a result, the system is capable of monitoring the sales data automatically and notifying the agent of any exceptions that occur. In addition, the system can propose certain markdowns in order to reach the planned sales figures. In this approach, the agent is relieved from a large portion of the activities he or she usually has to perform. Using the markdown profile, the agent can obtain proposed markdowns for a given product at periodic intervals over the life cycle of the sale of that product. The agent can choose to accept or reject the proposals, but it is envisioned that in most cases, the proposals will be accepted and the goal of ensuring that nearly all the merchandise is sold by the end of the season is achieved.

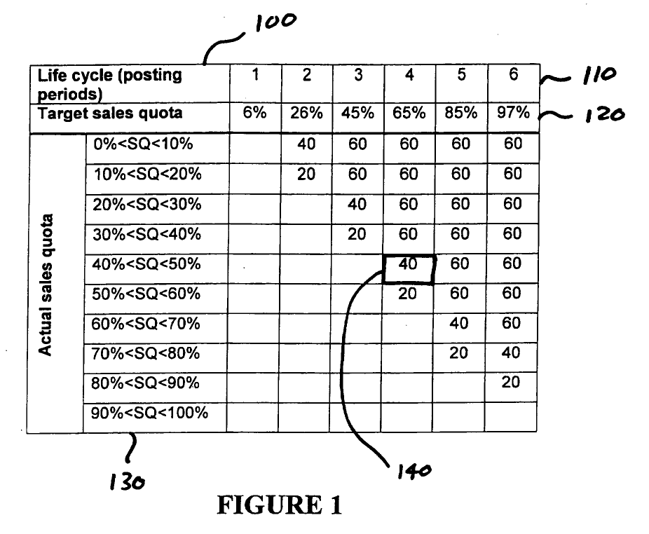

The structure of a markdown profile 100 in an exemplary embodiment of the present invention is illustrated in FIG. 1. Markdown profile 100 specifies the target sales figures for a product or service, that is, the sales quotas for which no markdowns are needed. These target sales quotas are shown in a row 120 in FIG. 1. The target sales quotas are shown in connection with a time reference, which may represent a retail life cycle of the product. In FIG. 1, the target sales quotas 120 are shown in connection with corresponding numbered time periods 110 over the life cycle of the product, also known as posting periods. For example, a posting period may correspond to a week in the season of the product.

The target sales quotas in row 120 are expressed as percentages in markdown profile 100 shown in FIG. 1. These percentages represent the quantity of the products sold divided by the quantity of the products available for sale. Thus, in the example shown in FIG. 1, at the end of the first posting period the target sales quota is six percent. At the end of the second posting period the target sales quota is 26 percent. By the end of the sixth posting period, most of the retail product, that is 97 percent, is targeted to have been sold. As shown in markdown profile 100 in FIG. 1, these target sales quotas are arranged along an axis in the table. Arranged perpendicular to the target sales quota axis is a plurality of rows representing ranges of actual sales quotas. These are shown in a column 130 in FIG. 1. As with target sales quota, actual sales quota is calculated by taking the actual quantity of products sold and dividing it by the quantity of products available for sale. Each of the ten ranges of actual sales quota shown in column 130 represent 10 percent intervals. It would apparent to one skilled in the art that any number of ranges or actual percentages could be used. The thresholds for the actual sales quota can be freely defined by the user.

In markdown profile 100, at the intersection of each actual sales quota range 130 and each target sales quota 120 corresponding to a posting period 110 lies a cell which contains the proposed markdown. Cells in which no numbers appear indicate that no markdown is proposed. For cells in which numbers do appear, the number indicates the proposed markdown percentage. For example, assume that markdown profile 100 shown in FIG. 1 is being used for a retail product that has been on sale for four posting periods (or four weeks). The sales quota targeted for this product is 65 percent, as shown in target sales quota row 120. Now assume that sales of this product have not met the targeted sales quota and, instead, only 235 out of the 500 items that were in stock have sold. This corresponds to an actual sales quota of 47 percent. Thus, using the markdown profile with the actual sales quota of 47 percent falling within the range of 40 percent to 50 percent, we look to the cell found at the intersection of this actual sales quota range with the target sales quota column of 65 percent and find the number 40 in cell 140. This indicates a proposed markdown of 40 percent.

Thus, in the example described above, the system would indicate to the user that a markdown of 40 percent of the original retail price is proposed. The user can then accept or reject this proposal. In an alternate embodiment of the invention, the proposed markdown from the markdown profile is automatically implemented to adjust the retail price of the product. The user can override this automatic adjustment. The process is repeated at subsequent posting periods over the retail life cycle of the product.

While percentage markdowns are shown in markdown profile 100 illustrated in FIG. 1, it is envisioned that other types of buying incentives could be used instead of a simple percentage markdown of retail price. For example, a markdown profile could propose a distribution of a coupon in order to encourage sales to achieve the target sales quota.

It is important to note that the computer system on which the markdown profile is running and implemented has access to the data necessary to propose the markdown to the user. That is, the system has access to the actual sales from the relevant store or stores for the relevant product or products during the relevant posting periods. It is envisioned that multiple markdown profiles would be provided to the user. These multiple profiles would correspond to different types of products or perhaps would be specific to individual products. The user could also create new profiles or revise existing profiles as desired.

To better control pricing for the sale of a retail product using markdown profiles, a user may select a markdown profile to be used for the retail product at issue. The user may also select the initial retail price for that product and, as time progresses, adjust the retail price of that product by the markdown determined from the markdown profile as described above. This adjustment could happen multiple times over the life cycle of the product. The system may be programmed to perform the adjusting step at regular intervals such as at the end of each posting period. In this case, it is envisioned that for a product selling well no mark-down may be necessary under certain posting periods.

Not shown in FIG. 1 is a data field associated with a markdown profile that pertains to some product characteristic. This data field allows for a markdown profile to be identified as relevant to a specific retail product or to a specific category of retail products. The assignment of a markdown profile to a retail product or products is described in further detail herein.

As mentioned above, the user forms a correspondence between a product or service to be sold and a markdown profile. In an exemplary embodiment of the present invention, the user is provided with a plurality of markdown profiles from which to choose in order to select a markdown profile to be used for a particular product. These markdown profiles are prepared in advance of selection. Alternatively, the user can revise an existing markdown profile or even create an entirely new markdown profile to be used for the particular product.

In order to more efficiently search for potentially applicable and relevant markdown profiles, the markdown profile may contain at least one and possibly three or more assignable attribute fields. These fields contain attribute data regarding a product or service. For example, the fields may contain indicators representing the product type (e.g., raincoats), the color, the size, the sales organization (i.e., a grouping of stores, such as by geographic location), and the distribution channel (e.g., U.S. North, U.S. South, Europe Benelux, etc.). Also, there are predefined attribute fields that characterize a markdown profile and allow for searching. Such fields include: fashion grade, season category and season year, article hierarchy id and category. Using the attribute field information, the user can search for the markdown profile that best suits the user's need for a particular product or service.

Different markdown profiles can be prepared to address different reaction strategies and sales profiles. For example, three or more reaction strategies could be provided: aggressive, defensive and normal. These are subjective classifications relating to how quickly you want to reduce the inventory and are determined by, for example, the person determining the values in the markdown profiles. As another example, three or more sales profiles could be provided: linear, progressive and declining. A linear profile, for example, is one where if there is markdown of x at time period y, there would be a markdown of 2x at time period 2y. Different markdown profiles can be prepared to address each of these scenarios.

When selecting from among a plurality of markdown profiles, the user may toggle between them using a single action of a user-input device, such as a pressing a key on a keyboard. This single action may toggle between multiple markdown profiles. In the case of reaction strategies and sales profiles, the single action may toggle between the various versions of the markdown profile.

In forming the correspondence between products or services and markdown profiles, the user can assign a markdown profile to entire groups or categories of products or services. For example, one markdown profile can be assigned to all products of a particular type (e.g., raincoats). The user can also more finely correspond specific markdown profiles to sub-groupings of those products. For example, the user could assign a different markdown profile to red raincoats than is assigned to blue raincoats and different than is assigned to the larger category of all raincoats. Indeed, a markdown profile may be specifically tailored for a particular product of a particular color and size. In the preferred embodiment, if an individual product is not separately assigned a specific markdown profile, then the markdown profile for the relevant larger product category may be used for that product.

While the markdown profile in FIG. 1 is shown as a table, it would be apparent to one skilled in the art that any suitable configuration could be used to convey the same information, and all such configurations would be within the scope of the present invention. Furthermore, the markdown profiles can represent information about the sales of a product or service in a given store or for a group of stores. It could also represent information about the sales of a group or category of products or services.

It is envisioned that a company will have in place limited budgets for applying markdowns to the retail prices of products or services. A company may not wish to allow its agent to markdown prices of products or services by significant amounts and for extended periods of time. Accordingly, they may put in place limited markdown budgets for a given product or for a given group of products. In an embodiment of the present invention, when a markdown is proposed, this budget will be checked in order to prevent application of markdowns that will exceed the budgeted amount. In this way, some additional control is exerted over the agents and some additional safety measures are placed on the operation of the system.

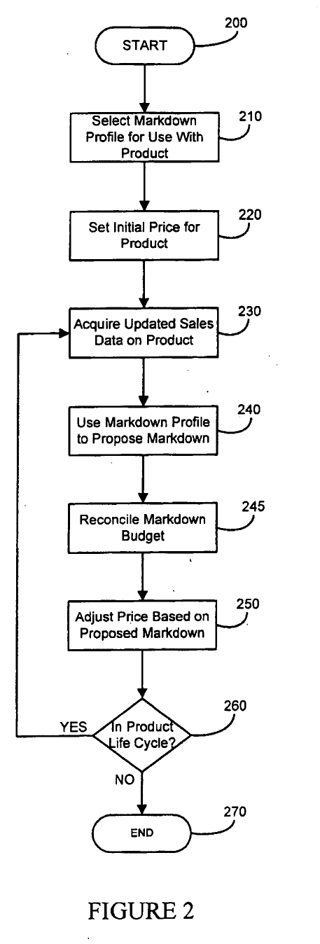

FIG. 2 is a flow chart illustrating one embodiment of the present invention with a focus on markdown budget reconciliation. The flowchart begins at a step 200. In a step 210, the user or the system selects a markdown profile to be used for a retail product. In a step 220, which may be performed before, after or contemporaneously with step 210, the initial retail price of the product is set. A step 230 illustrates the acquisition of updated sales data after some period of time has elapsed while the product has been on sale. This sales data is used in a step 240 in the markdown profile to determine the proposed markdown for the retail product.

In the illustrated embodiment, before a proposed markdown is applied to adjust the retail price of a product, a reconciliation of the markdown budget is performed based on the proposed markdown. This shown in a step 245 in FIG. 2. During this reconciliation, the system determines whether, based on predetermined budget rules, a proposed markdown can actually be applied to adjust the retail price of a product. This determination is made based on whether application of the proposed markdown would result in exceeding the available markdown budget. The predetermined budget rules may include some tolerance factor such that if the budget is exceeded but within the tolerance, it would still allow the markdown to be applied.

If it is determined during reconciliation step 245 that a proposed markdown can indeed be applied to the retail price of a product, the price is then adjusted based on the proposed markdown as shown in a step 250. If it is determined during reconciliation step 245 that a proposed markdown cannot be applied to the retail price of a product, then the proposed markdown is not applied to adjust the price of the product. In an alternate embodiment of the invention, the system would calculate the amount of markdown that could be applied while still complying with the predetermined rules regarding the available markdown budget. This allowable markdown could then be applied to adjust the retail price of the product.

In another embodiment of the invention, the proposed markdown is subject to approval or rejection by a user and, in the case of rejection, adjustment step 250 need not be performed. In any event, the exemplary method returns to acquiring updated sales data in step 230 so long it is still within the product lifecycle as determined in a step 260. The frequency of acquiring updated sales data and determining a markdown can be adjusted by the user. In the preferred embodiment, it is performed once per posting period. Once the life cycle of the product has been exhausted, it is assumed that the product will not be offered for sale until some later time, if at all, and the use of the markdown profile is ended in a step 270.

“Article,” “seasonal product,” “product” and “retail product” are terms used herein to refer to the merchandise being sold, the pricing for which is controlled or affected by the markdown profile as used in the present invention. It is envisioned that the present invention will be applicable to the sale of any type of product or service. Hence, the term “product” herein is intended to encompass a service. Furthermore, the slow seller management method as described above is preferably implemented on one or more computers.

As noted above, embodiments within the scope of the present invention include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above are also to be included within the scope of computer-readable media. Computer-executable instructions comprise, for example, instructions and data which cause a general purpose computer, special purpose computer, or special purpose processing device to perform a certain function or group of functions.

The invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

The present invention in some embodiments, may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the present invention might include a general purpose computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer-readable media provide nonvolatile storage of computer-executable instructions, data structures, program modules and other data for the computer.

Software and web implementations of the present invention could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the present invention has been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principals of the present invention and its practical application to enable one skilled in the art to utilize the present invention in various embodiments and with various modifications as are suited to the particular use contemplated.

1. A method of managing the sale of a product, comprising:
determining if said product is a slow seller;
determining a markdown to be applied to a price of said product;
reconciling a markdown budget with said determined markdown to be applied to said price to determine whether said markdown will be applied; and
adjusting said price of said product by said markdown.

2. A method of managing the sale of a product according to claim 1, wherein said markdown is determined using a markdown profile.

3. A method of managing the sale of a product according to claim 1, wherein said step of determining if said product is a slow seller further comprises applying a predetermined rule set to said product.

4. A method of managing the sale of a product according to claim 3, wherein said predetermined rule set includes at least one of: past sales, stock values and accrued cost of inventory for said product.

5. A method of managing the sale of a product according to claim 1, wherein said step of determining if said product is a slow seller is performed at a predetermined frequency.

6. A method of managing the sale of a product according to claim 1, wherein said step of determining if said product is a slow seller is performed at a predetermined time.

7. A method of managing the sale of a product according to claim 1, further comprising performing additional remedial measures to address lagging sales of said product determined to be a slow seller, said remedial measures comprising at least one of: change in presentation of said product, returning quantities of said product to a vendor, modifying follow-on orders, discontinuation of said product, modification of replenishment parameters, transfer of stock between stores and implementing use in bonus quantity.

8. A method of managing the sale of a product according to claim 1, further comprising receiving updated actual sales information after application of said markdown and using said updated sales information to determine if said product continues to be a slow seller and repeating the remaining steps in said method.

9. A method of managing the sale of a product according to claim 1, further comprising using determinations of slow sellers for at least one of merchandise planning, assortment planning and key article planning in a subsequent time period.

10. A system for managing the sale of a product, comprising:
means for determining if said product is a slow seller;
means for determining a markdown to be applied to a price of said product;
means for reconciling a markdown budget with said determined markdown to be applied to said price to determine whether said markdown will be applied; and
means for adjusting said price of said product by said markdown.

11. A system for managing the sale of a product according to claim 10, wherein said markdown is determined using a markdown profile.

12. A system for managing the sale of a product according to claim 10, wherein said means for determining if said product is a slow seller further applies a predetermined rule set to said product.

13. A system for managing the sale of a product according to claim 12, wherein said predetermined rule set includes at least one of: past sales, stock values and accrued cost of inventory for said product.

14. A system for managing the sale of a product according to claim 10, wherein in said means for determining if said product is a slow seller, said determination is performed at a predetermined frequency.

15. A system for managing the sale of a product according to claim 10, wherein in said means for determining if said product is a slow seller, said determination is performed at a predetermined time.

16. A system for managing the sale of a product according to claim 10, further comprising means for performing additional remedial measures to address lagging sales of said product determined to be a slow seller, said remedial measures comprising at least one of: change in presentation of said product, returning quantities of said product to a vendor, modifying follow-on orders, discontinuation of said product, modification of replenishment parameters, transfer of stock between stores and implementing use in bonus quantity.

17. A system for managing the sale of a product according to claim 10, further comprising means for receiving updated actual sales information after application of said markdown and using said updated sales information in said means for determining if said product is a slow seller.

18. A system of managing the sale of a product according to claim 10, further comprising using determinations of slow sellers for at least one of merchandise planning, assortment planning and key article planning in a subsequent time period.

19. A program product for managing the sale of a product, said program product comprising machine-readable program code for causing, when executed, one or more machines to perform the following method steps:
determining if said product is a slow seller;
determining a markdown to be applied to a price of said product;
reconciling a markdown budget with said determined markdown to be applied to said price to determine whether said markdown will be applied; and
adjusting said price of said product by said markdown.

20. A program product for managing the sale of a product according to claim 19, wherein said markdown is determined using a markdown profile.

21. A program product for managing the sale of a product according to claim 19, wherein said step of determining if said product is a slow seller further comprises applying a predetermined rule set to said product.

22. A program product for managing the sale of a product according to claim 21, wherein said predetermined rule set includes at least one of: past sales, stock values and accrued cost of inventory for said product.

23. A program product for managing the sale of a product according to claim 19, wherein said step of determining if said product is a slow seller is performed at a predetermined frequency.

24. A program product for managing the sale of a product according to claim 19, wherein said step of determining if said product is a slow seller is performed at a predetermined time.

25. A program product for managing the sale of a product according to claim 19, further comprising performing additional remedial measures to address lagging sales of said product determined to be a slow seller, said remedial measures comprising at least one of: change in presentation of said product, returning quantities of said product to a vendor, modifying follow-on orders, discontinuation of said product, modification of replenishment parameters, transfer of stock between stores and implementing use in bonus quantity.

26. A program product for managing the sale of a product according to claim 19, further comprising receiving updated actual sales information after application of said markdown and using said updated sales information to determine if said product continues to be a slow seller and repeating the remaining steps in said method.

27. A program product for managing the sale of a product according to claim 19, further comprising using determinations of slow sellers for at least one of merchandise planning, assortment planning and key article planning in a subsequent time period.
